(19) United States
(12) Patent Application Publication
(10) Pub. No.: US 2003/0158609 A1
(43) Pub. Date: Aug. 21, 2003

(54) Power saving management for portable devices

(75) Inventor: Tom Chiu, Sunnyvale, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/154,060

(22) Filed: May 21, 2002

Related U.S. Application Data
(60) Provisional application No. 60/358,483, filed on Feb. 19, 2002.

(51) Int. Cl. G05B 11/01

(52) U.S. Cl. 700/22

(57) ABSTRACT

A power management system for a portable device uses a variety of techniques for dynamically controlling the allocation of power among components of the portable device. A power-priority scheme progressively disables, or reduces the power to, individual components of the device, such that lesser important functions are disabled sooner, to provide a longer power duration to more important functions, such as data-retention functions. A performance-dependent scheme continuously adjusts the power to select components to maintain a minimum performance level, thereby avoiding power consumption for more-than-necessary performance. A user of the device is provided options for effecting the desired power-prioritization, and levels of performance.

This application claims the benefit of U.S. Provisional Application No. 60/358,483, filed Feb. 19, 2002, Attorney Docket US028014P.

### BACKGROUND OF THE INVENTION

1. Field of the Invention

This invention relates to the field of electronic systems, and in particular to a method and system for power saving management for battery powered devices.

2. Description of Related Art

Portable electronic devices are becoming increasingly versatile. Personal Data Assistants (PDAs) include wireless networking capabilities, portable telephones include phone-books and appointment calendars, many devices are being equipped with Global Positioning Systems (GPS), and so on.

Most portable systems include some form of power monitoring and management. In a simple embodiment, the system notifies the user of an impending power depletion minutes, to give the user an opportunity to connect the device to a recharger, to save critical data, and so on. In a more complex embodiment, a user is given options regarding features that are enabled or disabled during operation. For example, in a portable computer device, the user may specify how long to wait before turning the display off during periods of inactivity, how long to wait before placing the system in a low-power standby mode, at what power level to issue a warning, at what power level to turn the system off, and so on.

To facilitate the setting of the above power saving options, some systems include pre-defined profiles, with descriptive names, such as “Super Power Saver”, “Miser”, “High Performance”, “Projector Presentation”, and so on. When the user selects one of these profiles, the device is configured using predefined parameters for each of the profiles. For example, in the “miser” profile, the inactivity time parameter for turning the display off may be set to three minutes, whereas, in the “projector presentation” profile, the inactivity time parameter may be set to at least an hour. In like manner, a disk drive may be set to turn off during periods of inactivity when the device is operated on battery power, but to remain on when the device is connected to a power supply.

A common problem in conventional power management systems is the “static” nature of the criteria used to effect power savings. For example, when the aforementioned personal computer is operated in the “miser” power-saving mode, the display is turned off within three minutes of inactivity, regardless of other factors. In like manner, the aforementioned disk drive is turned off during periods of inactivity whenever the device is on battery power, regardless of other factors. Further, in a conventional system, when the power level drops below the specified minimum, the entire system is turned off, or placed in a standby mode, again regardless of other factors. Further, in a conventional system, the power management is based on available power level, and a rapid dissipation of power can induce a power failure that occurs before the power manager can react to the decreased power level. Such a power failure often results in a loss of data.

### BRIEF SUMMARY OF THE INVENTION

It is an object of this invention to further facilitate power management in a portable electronic device. It is a further object of this invention to progressively enter a low-power, or standby, mode as the available power decreases. It is a further object of this invention to avoid power failures that cause a loss of data.

These objects, and others, are achieved by providing a power management system for a portable device that uses a variety of techniques for dynamically controlling the allocation of power among components of the portable device. A power-priority scheme progressively disables, or reduces the power to, individual components of the device, such that lesser important functions are disabled sooner, to provide a longer power duration to more important functions, such as data-retention functions. A performance-dependent scheme continuously adjusts the power to select components to maintain a minimum performance level, thereby avoiding power consumption for more-than-necessary performance. A user of the device is provided options for effecting the desired power-prioritization, and levels of performance.

### BRIEF DESCRIPTION OF THE DRAWINGS

The invention is explained in further detail, and by way of example, with reference to the accompanying drawings wherein:

FIG. 1 illustrates an example block diagram of a power management system in accordance with this invention.

FIGS. 2A-2C illustrates example user interfaces to a power management system in accordance with this invention.

Throughout the drawings, the same reference numerals indicate similar or corresponding features or functions.

### DETAILED DESCRIPTION OF THE INVENTION

As discussed above, in a conventional portable device, when the available power drops below a certain limit, the device is placed in an inactive or standby state to minimize further power depletion. In some systems, the user is provided options for specifying the power level at which to invoke the device inactive or standby state. This application is premised on two related observations.

The first observation is that, in a multi-function device, users do not view all functions to be of equal importance, and/or that the importance of each function may vary, depending upon the intended use of the device in different situations or environments. For example, a multifunction PDA device may include a communications device for voice or data communications. A user may have purchased this device as a PDA-with-communications device, or as a communicator-with-PDA device, depending upon the user's perceived primary use of the device.

The second observation is that, in a multi-function device, some functions consume substantially more power than other functions. Using the PDA example, connection to a wireless network, such as an 802.11b network, consumes substantially more power than the conventional computer functions provided by a PDA. Conventional power management systems react to a measure of currently-available-power and are configured to effect power management actions, such as shutting the system down before data is lost, based on this measure. A certain period of time elapses between the time that the low power level is detected and the time that the system is shut down. If the reaction time exceeds the time required to deplete the available power at the current rate of usage, the power management will be ineffective for preventing data loss.

Data loss in a conventional system can be prevented by setting a fairly high threshold level for shutting the system down, to assure that, regardless of the actual power utilization rate, the system will shut down before the available power is dissipated, the effective battery-life of the device will be substantially diminished, because this high threshold level must be set based on the maximum possible power dissipation of the device.

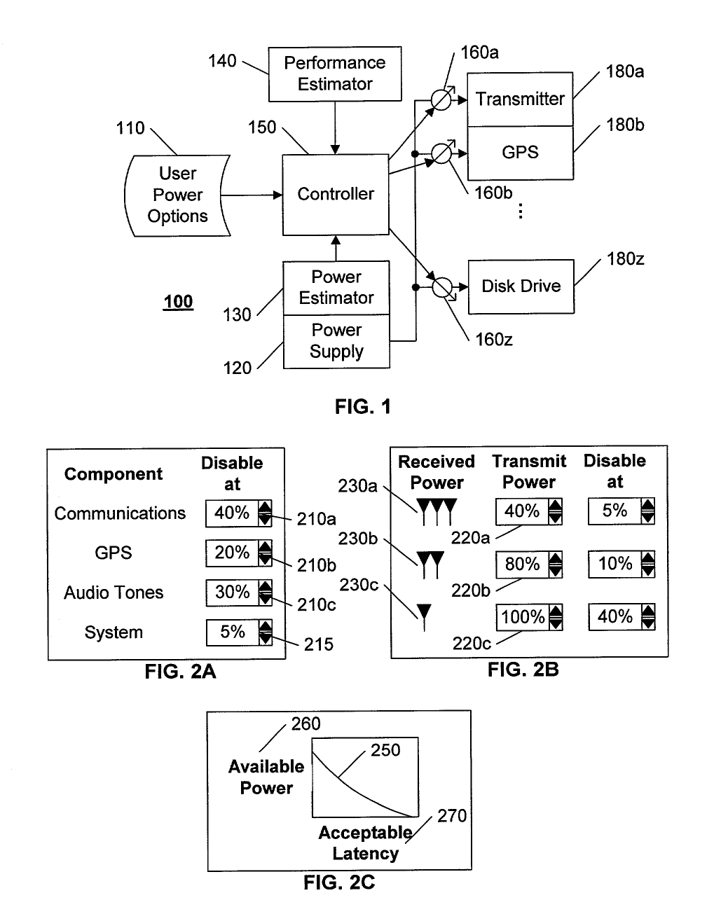

FIG. 1 illustrates an example block diagram of a power management system 100 in accordance with this invention. Of particular note, a controller 150 is configured to independently control the power that is supplied from a power supply 120 to individual components 180a-z within a portable device. The power estimator 130 provides a measure, or estimate, of currently available power from the power supply 120 to the controller 150 to effect this power-dependent control.

By independently controlling the power to each component 180a-z within the device, a user's priority can be accomodated for allocating power to functions or components that are deemed to be more important to that user, or for the particular situation that the user encounters. Also, by independently controlling the power to each component 180a-z within the device, power can be allocated based on the power consumption of each component, to assure that high power consuming components are shut down sooner than low power consuming components, thereby improving the effective battery life without risking a loss of data.

In accordance with this invention, the user may choose to independently reduce power 160a-z to select components 180a-z as the available power diminishes, to allocate the remaining available power to components of higher importance, or priority. For example, a PDA-with-communicator user may specify, via user power options 110, that communication components be disabled when the available power drops below 50%, and that the PDA computer components should remain enabled until the available power drops below 3%. During the period that the communication components are disabled, less power is being consumed by the device, thereby extending the remaining time available for using the PDA components of the device. In a preferred embodiment of this invention, the system is configured to preset a minimum power level cutoff for each component, to assure that the component is shut off within the nominal reaction time of the power management process. That is, for example, the system may be configured to prevent the user from decreasing the cutoff level of the transmitter 180a below 10%, if the transmitter can consume that remaining 10% within the reaction time of the power management system.

A user that places a priority on communications, on the other hand, may configure the system to disable the PDA components when the available power drops below 40%, and to disable the transmitter when the available power drops below 15%.

Depending upon the modularity and functions of the device, the user may configure select sub-functions of the device to remain active while disabling others. For example, a user may configure the system to disable the transmission of messages when the power drops below a given percentage, but to keep a receiver function active, to receive e-mails or other transmissions to the device.

In like manner, if the user is in an environment wherein it will be easy to recharge the device, the user may configure the system to keep all functions active until the available power drops below a given level; whereas, if the user is traveling, the user may configure only a select few functions to remain active as the available power level decreases, to extend the period between required rechargings.

Similarly, the power management system 100 of this invention may be configured to dynamically decrease the inactivity-parameters used to turn off displays and the like, based on decreasing available power. That is, for example, the controller 150 may be configured to turn a display off after five minutes of inactivity when the available power is high, and to turn the display off after only two minutes of inactivity when the available power is less than half. This dynamic decrease may be effected as a step function, or as a continuous function. In like manner, the power management system of this invention may dynamically adjust the power level of a transmitted signal as a function of the available power, discussed further below.

In addition to the currently-available-power characteristic, the controller 150 of a preferred embodiment of the power management system 100 is also configured to respond to other current characteristics of the device, as provided, for example, by a performance estimator 140. Adjusting the allocated power to a component 180a-z can be expected to affect the performance of the device in some manner. For example, reducing the power level of a transmitter 180a can be expected to reduce the transmission range of the device. In like manner, reducing the speed of an internal bus clock can be expected to reduce the data transfer rate of the bus, and so on. In accordance with this invention, the performance estimator 140 is configured to estimate, either directly or indirectly, a performance factor of the device that is correlated to the power allocation to a component 180a-z. If the estimated performance exceeds a specified acceptable level, the power allocation is decreased, thereby extending the expected battery life. If the estimated performance is below a specified minimum level, the power allocation is increased. Although the acceptable level and the minimum level may be the same value, the use of two different levels avoids a continuous adjustment of power levels while still providing a power allocation that is responsive to device performance.

In the specific example of power allocation to a transmitter, the effective range of the device can be assumed to be correlated to transmit power. That is, the device can transmit at a lower power level when the target receiver is closer, and must transmit at a higher power level when the target receiver is at a farther distance. If the target receiver provides a measure of received power level to the transmitting device, this measure can be used to adjust the power level of the transmitter to achieve some acceptable received power level. Generally, however, the target receiver does not provide this feedback, and an alternative measure is required. In a preferred embodiment of this invention, the received power level from a target base station, or access point, can be assumed to also be correlated to the distance between the device and the target. Thus, a measure of the received power from the target can be used to indirectly determine an acceptable transmit level to provide sufficient range to the target. That is, the measure of received power is a measure of distance to the target, and adjusting the transmit power affects the distance that the device can achieve reliable communications. A mapping of received power to required transmit power can be created, given the aforementioned correlations of power to distance. Alternatively, a simple heuristic may be employed, such as: if the received power level is high, allocate 50% power to the transmitter; if the received power is mediocre, allocate 75%; if the received power is very low, allocate 100%.

A combination of current-characteristics may also be used to dynamically allocate power to one or more components 180a-z of the device. In the prior transmit-power allocation example, the heuristic rule may be modified to include the currently-available-power characteristic as well. As a simple example, if the received power is very low, and the currently-available-power is below a given threshold, the transmitter 180a may be disabled, rather that fully-powered, to conserve power for communications that are more likely to get through when the device is brought closer to the target base station, as measured by the performance estimator 140 based on the received power levels. In like manner, if multiple alternative targets are currently available, and the currently-available-power is low, the controller 150 may be configured to force a hand-off from one target to another, based on the received power levels from each of the alternative targets, to allow the transmitter to be allocated less power. These and other combinations of power allocation rules will be evident to one of ordinary skill in the art in view of this disclosure.

FIGS. 2A-2C illustrates example user interfaces to a power management system in accordance with this invention. As would be evident to one of ordinary skill in the art, any of a variety of techniques can be employed to secure user preferences and options, and these examples are merely provided to illustrate select concepts of this invention.

FIG. 2A illustrates an interface that allows a user to individually specify a power level 210a-c at which each of the identified components is to be disabled. Consistent with conventional power management processes, the interface also allows the user to specify the power level 215 at which the entire system/device should be disabled. By allowing individual components to have different power-level cutoffs, the user effectively is able to distinguish each component with regard to power allocation. The example power levels indicate that the power-priority of each component: GPS is a higher priority function or component than Audio Tones, which is a higher priority function or component than Communications. As an alternative to a direct specification of individual power levels, the user may be provided the option of specifying the power-priority of each component in a rank-order, and the system automatically determines a power-level cutoff for each component, based on the rank-ordering and the relative amount of power consumed by each.

FIG. 2B illustrates an interface that allows a user to specify a combination of characteristics for determining preferred adjustments to transmit power, based on a measure of a performance associated with the device. As noted above, a measure of received power is an indirect measure of range to the target receiver, and thus for the purposes of this invention, is considered an estimate of the range performance required by the transmitter. In FIG. 2B, the user is provided the option of specifying a transmit power 220a-c that is based on the measure received power 230a-c, indicated by the number of ‘antenna icons’ that are commonly displayed on wireless devices to indicate received power levels. Alternatively, text terms such as “high”, “medium”, and “low” might be used. In this example, when the received power is high 230a, the power manager reduces the transmit power to 40% 220a of the transmitter's total power output. The power manager will provide this reduced power to the transmitter while the received power is high for as long as the available power is over 5%. At a low received power level 230c, the controller provides full power 220c to the transmitter, but only if the available power is over 40%. In this manner, the transmitter component is configured to receive power based on a performance measure as well as an available power measure.

FIG. 2C illustrates an example graphic interface for specifying acceptable system performance as a function of available power. In this example, the user is provided options for modifying the shape of the curve 250 to specify acceptable latency measures 270 as a function of the available power 260. Adjusting a system clock, for example, may control this latency. As the available power 260 decreases, the acceptable latency 270 increases. The controller 150 of FIG. 1 uses this curve 250 to determine an appropriate/acceptable decrease in clock rate as the currently available power in the device decreases. The performance estimator 140 in this example may be configured to directly or indirectly measure latency within the device, or, its function may be replaced by an assumed mapping between clock rate and latency. This same graphic interface technique may also be used to specify the desired correlation between received power and transmit power, discussed above.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the specific components of FIG. 1 are illustrated for ease of understanding, and alternative component arrangements can be used to provide the functions of the illustrated components. For example, as discussed above, there may be a known correspondence between a parameter that is controlled by the controller 150 and a performance factor, and the controller 150 in the setting of the parameter effectively provides the function of the performance estimator 140. Similarly, select functions, or select portions of functions may be provided as software routines that are executed in devices that are used in common with other functions that are unrelated to power management. These and other system configuration and optimization features will be evident to one of ordinary skill in the art in view of this disclosure, and are included within the scope of the following claims.

I claim:

1. A method of managing power allocation in a device having a plurality of components, comprising:
determining one or more current characteristics of the device, and
allocating power to each component of a plurality of components of the device based on the one or more current characteristics of the device, and based on a user preference that distinguishes at least one component of the plurality of components relative to the one or more current characteristics of the device.

2. The method of claim 1, wherein
the one or more current characteristics include a measure of currently available power, and
the user preference distinguishes the at least one component via a power-priority parameter that is associated with the at least one component, and
allocating power to each component includes
selectively allocating power to the at least one component based on a comparison of the measure of currently available power to the power-priority parameter of the at least one component.

3. The method of claim 1, wherein
the one or more current characteristics include a measure of performance associated with the device, and
allocating power to at least one component is further based on the measure of performance.

4. The method of claim 3, wherein
the measure of performance includes at least one of: a received power, a clock speed, a transmitted power, and a latency.

5. The method of claim 1, wherein
allocating power to each component is further based on:
a rate of power consumption by each component, and
a reaction time corresponding to a reallocation of power.

6. A device comprising:
a power supply,
a first component, operably coupled to the power supply,
a second component, operably coupled to the power supply,
a monitor that is configured to monitor one or more current characteristics of the device, and
a controller that is configured to independently allocate power from the power supply to each of the first component and the second component, based on the one or more current characteristic.

7. The device of claim 6, wherein
the controller is further configured to independently allocate the power based on a rate of power consumption of the first component.

8. The device of claim 6, wherein
the controller is further configured to independently allocate the power based on a user preference.

9. The device of claim 6, wherein
the one or more current characteristics include a measure of currently available power from the power supply.

10. The device of claim 9, wherein
the controller is further configured to independently allocate the power based on a user preference that distinguishes control of the first component from control of the second component based on the measure of currently available power.

11. The device of claim 6, wherein
the one or more current characteristics include a measure of performance associated with the device.

12. The device of claim 11, wherein
the measure of performance includes at least one of: a received power, a clock speed, a transmitted power, and a latency.

13. A portable device comprising:
a power supply,
a computer component, operably coupled to the power supply,
a communication component, operably coupled to the power supply, and
a power management component that is configured to independently allocate power from the power supply to each of the computer component and the communication component, based on a user preference.

14. The portable device of claim 13, further including
a power monitor that is configured to monitor a measure of currently available power,
wherein
the power management component is further configured to independently allocate the power based on the measure of currently available power.

15. The portable device of claim 13, wherein
the user preference includes a power-priority parameter that is associated with the communication component, to facilitate control of the power to the communication component independent of the power to the computer component.

16. The portable device of claim 13, further including
a performance monitor that is configured to monitor a measure of performance associated with the portable device,
wherein
the power management component is further configured to independently allocate the power based on the measure of performance.

17. The portable device of claim 16, wherein
the measure of performance includes a measure of communication link quality, and
the power management component is configured to modify power that is provided to a transmitter of the communication component based on the measure of communication link quality.

18. The portable device of claim 17, wherein
the communication component is further configured to select from among a plurality of available target receivers, based on the measure of communication link quality, to facilitate a reduction in the power that is provided to the transmitter.
